(19) United States
(12) Patent Application Publication
(10) Pub. No.: US 2010/0161693 A1
(43) Pub. Date: Jun. 24, 2010

(54) SYSTEM AND METHOD FOR SIGNING AN ELECTRONIC DOCUMENT

(75) Inventors: CHUNG-I LEE, Tu-Cheng (TW); XIN-YU HUANG, Shenzhen City (CN); LV-HONG WU, Shenzhen City (CN); ZHI-XIANG XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/510,439

(22) Filed: Jul. 28, 2009

(30) Foreign Application Priority Data
Dec. 18, 2008 (CN) 200810306339.9

(51) Int. Cl. G06F 17/30

(52) U.S. Cl. 707/827; 707/E17.006; 707/E17.127

(57) ABSTRACT

A system and method for signing an electronic document obtains a signing tag and document content from a data base to generate an extensible markup language (XML) file of the electronic document. The system and method further converts the XML file to an extensible stylesheet language formatting objects (XSL-FO) file, and converts the XSL-FO file to a portable document format (PDF) file. Furthermore, the method obtains a signing position of the PDF file according to the signing tag and inserts an electronic signature into the PDF file according to the signing position.

### BACKGROUND

1. Technical Field

Embodiments of the present disclosure relate to information management systems and methods, and more particularly to a system and method for signing an electronic document.

2. Description of Related Art

Signatures are a very important because many documents (such as contracts or orders) need to be signed by a leader. For example, a purchase order will be not performed if the purchase order is not authorized and signed by the leader. Conventionally, paper orders are submitted to the leader to be signed. Due to problems, the time it takes to sign the paper orders can take a long time. In October 2000, the federal Electronic Signatures in Global and National Commerce Act (also known as “E-Sign”) was enacted. The new law broadly authorizes electronic records and electronic signatures as being legally effective. However, in existing electronic documents signing system, an electronic signature of a signer is only permitted to sign on a fixed position, such as at bottom of the electronic document. If the electronic signature of the signer is signed on another position, such as at middle of the electronic document, then the signature will be displayed on a wrong position. Therefore, there is a need for a system and method to overcome the aforementioned problem.

### BRIEF DESCRIPTION OF THE DRAWINGS

FIG. 1 is a block diagram of one embodiment of a system for signing an electronic document;

FIG. 2 is a block diagram of one embodiment of an application server of FIG. 1; and

FIG. 3 is a flowchart of one embodiment of a method for signing the electronic document.

FIG. 4 illustrates one embodiment of a portable document format (PDF) file with an electronic signature.

### DETAILED DESCRIPTION

All of the processes described below may be embodied in, and fully automated via, function modules executed by one or more general purpose processors of a computer. Some or all of the methods may alternatively be embodied in specialized hardware. The function modules may be stored in any type of computer-readable medium or other computer storage device.

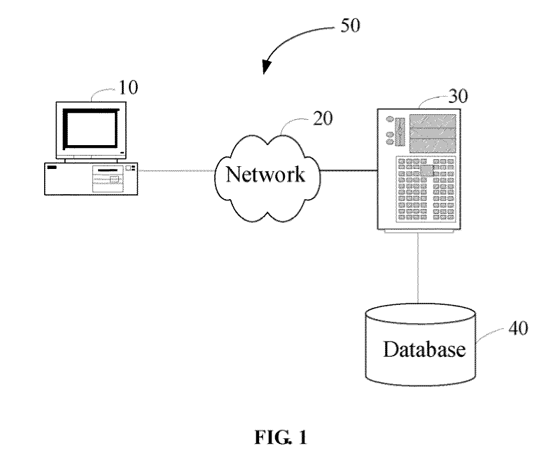

FIG. 1 is a block diagram of one embodiment of a system 50 for signing an electronic document. In one embodiment, the system 50 may comprise an application server 30, a database 40 connected to the application server 30, and one or more client computers 10 (only one shown). In one embodiment, the application server 30 may be used to produce an electronic document to be electronically signed using an electronic signature. The electronic signature may be generated using, but not limited to, a scanner or a digital pen. The electronic signature may be positioned on a determined area of the electronic document. The electronic document may be, but not limited to, an electronic contract or an electronic order.

The one or more client computers 10 communicate with the application server 30 via a network 20. In one embodiment, the application server 30 may be a personal computer (PC), a network server, or other appropriate data-processing equipment. Each of the one or more client computers 10 provides an operation interface for controlling one or more operations of the application server 30. The network 20 may be a wide area network (e.g., the Internet) or a local area network. The database 40 may be used to store the electronic document and a signature tag for the electronic document.

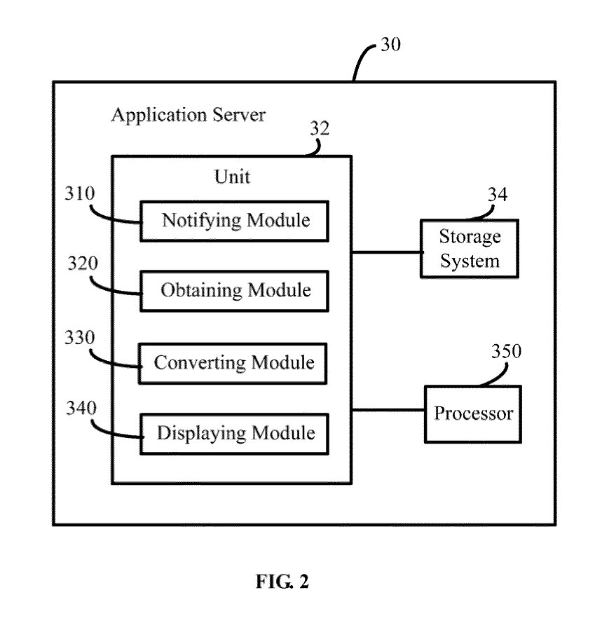

FIG. 2 is a block diagram of one embodiment of the application server 30 of FIG. 1 comprising a unit 32. The unit 32 may be used to sign the electronic document using the application server 30. In one embodiment, the unit 32 includes a notifying module 310, an obtaining module 320, a converting module 330, and an inserting module 340. One or more computerized codes of the modules 310-340 are stored in a storage system 34. One or more general purpose or specialized processors, such as a processor 350 executes the computerized codes of the modules 310-340 to provide one or more operations of the unit 32.

The notifying module 310 electronically sends a notification to an authorized signer to sign an electronic document if the electronic document exists in the application server 30. In one embodiment, the notification may be an e-mail or a short message.

The obtaining module 320 obtains the electronic document and a signature tag from the database 40 to generate an extensible markup language (XML) file of the electronic document. In one embodiment, the XML file of the electronic document comprises the signature tag and the electronic document. The signature tag is an electronic tag that is associated with a field in the electronic document. For example, the signature tag may be associated with a word or a sentence in the electronic document.

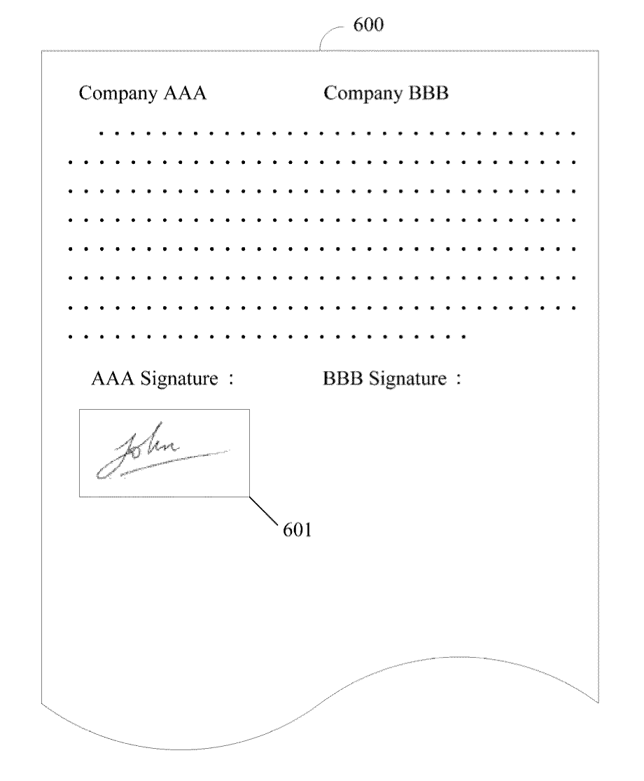

The converting module 330 converts the XML file to an extensible stylesheet language formatting objects (XSL-FO) file, and converts the XSL-FO file to a portable document format (PDF) file 600 (referring to FIG. 4). In one embodiment, the converting module 330 converts the XSL-FO file to the PDF file 600 using a formatting objects processor (FOP).

The obtaining module 320 further obtains a signature position of the PDF file according to the signature tag. In one embodiment, as shown in FIG. 4, if the signature tag is associated with a field “AAA Signature:” in the PDF file 600, then the obtaining module 320 obtains the signature position of the field “AAA Signature:” in the PDF file 600. The signature position comprises distances to page margins of the PDF file 600. The electronic signature may represent an electronic version of a hand-written signature, in one example.

The inserting module 213 obtains an electronic signature from the database 40 and inserts the electronic signature into the PDF file 600. In one embodiment, as shown in FIG. 4, the inserting module 213 inserts the electronic signature 601 into the PDF file 600.

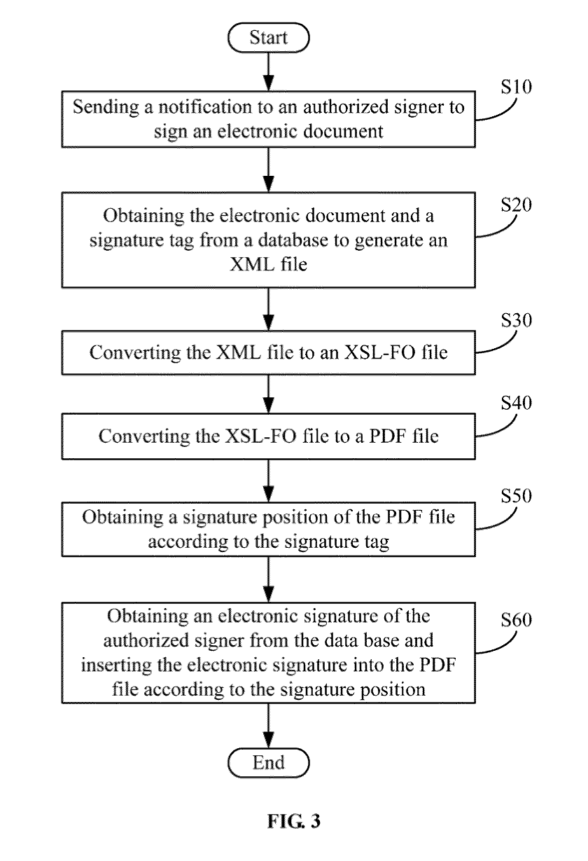

FIG. 3 is a flowchart of one embodiment of a method for signing an electronic document. Depending on the embodiment, additional blocks may be added, others deleted, and the ordering of the blocks may be changed.

In block S10, the notifying module 310 electronically sends a notification to an authorized signer to sign an electronic document if the electronic document exists in the application server 30. As mentioned above, the notifying module 310 may send an e-mail or a short message to notify the authorized signer. For example, the notifying module 310 may send an e-mail to the authorized signer according to a predetermined e-mail address of the authorized signer. In another example, the notifying module 310 may also send a short message to the authorized signer according to a predetermined telephone number of the authorized signer.

In block S20, the obtaining module 320 obtains the electronic document and a signature tag from the database 40 to generate an extensible markup language (XML) file of the electronic document. As mentioned above, the XML file of the electronic document comprises the signature tag and the electronic document.

In block S30, the converting module 330 converts the XML file to an XSL-FO file, and converts the XSL-FO file to a PDF file 600. As mentioned above, the converting module 330 converts the XSL-FO file to the PDF file 600 using a formatting objects processor (FOP).

In block S40, the obtaining module 320 obtains a signature position of the PDF file according to the signature tag. In one embodiment, as shown in FIG. 4, if the signature tag is associated with a field “AAA Signature:” in the PDF file 600, then the obtaining module 320 obtains the signature position of the field “AAA Signature:” in the PDF file 600. The signature position comprises distances to page margins of the PDF file 600.

In block S50, the inserting module 213 obtains an electronic signature from the database 40 and inserts the electronic signature into the PDF file 600. In one embodiment, as shown in FIG. 4, the inserting module 213 inserts the electronic signature 601 into the PDF file 600.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for signing an electronic document, the system comprising a storage system storing a plurality of programs and a processor that executes one or more operations for the plurality of programs, the programs comprising:
a notifying module operable to send a notification to an authorized signer of the electronic document, to sign the electronic document;
an obtaining module operable to obtain the electronic document and a signature tag from a database of the storage system, to generate an extensible markup language (XML) file of the electronic document;
a converting module operable to convert the XML file to an extensible stylesheet language formatting objects (XSL-FO) file, and to convert the XSL-FO file to a portable document format (PDF) file;
the obtaining module further operable to obtain a signature position of the PDF file according to the signature tag; and
an inserting module operable to obtain an electronic signature of the authorized signer from the database and insert the electronic signature into the PDF file according to the signature position.

2. The system of claim 1, wherein the electronic document is an electronic contract or an electronic order.

3. The system of claim 1, wherein the notification is an e-mail or a short message.

4. The system of claim 1, wherein the electronic signature is generated using a scanner or a digital pen.

5. The system of claim 1, wherein the signature position comprises distances to page margins of the PDF file.

6. A computer-implemented method for signing an electronic document, the method comprising:
(a) sending a notification to an authorized signer of the electronic document, to sign the electronic document;
(b) obtaining the electronic document and a signature tag from a database of the storage system, to generate an extensible markup language (XML) file of the electronic document;
(c) converting the XML file to an extensible stylesheet language formatting objects (XSL-FO) file, and converting the XSL-FO file to a portable document format (PDF) file;
(d) obtaining a signature position of the PDF file according to the signature tag; and
(e) obtaining an electronic signature of the authorized signer from the database and inserting the electronic signature into the PDF file according to the signature position.

7. The method of claim 6, wherein the electronic document is an electronic contract or an electronic order.

8. The method of claim 6, wherein the notification is an e-mail or a short message.

9. The method of claim 6, wherein the electronic signature is generated using a scanner or a digital pen.

10. The method of claim 6, wherein the signature position comprises distances to page margins of the PDF file.

11. A computer-readable medium having stored thereon instructions that, when executed by a computing device, causing the computing device to perform a method for signing an electronic document, the method comprising:
(a) sending a notification to an authorized signer of the electronic document, to sign the electronic document;
(b) obtaining the electronic document and a signature tag from a database of the storage system, to generate an extensible markup language (XML) file of the electronic document;
(c) converting the XML file to an extensible stylesheet language formatting objects (XSL-FO) file, and converting the XSL-FO file to a portable document format (PDF) file;
(d) obtaining a signature position of the PDF file according to the signature tag; and
(e) obtaining an electronic signature of the authorized signer from the database and inserting the electronic signature into the PDF file according to the signature position.

12. The medium of claim 11, wherein the electronic document is an electronic contract or an electronic order.

13. The medium of claim 11, wherein the notification is an e-mail or a short message.

14. The medium of claim 11, wherein the electronic signature is generated using a scanner or a digital pen.

15. The medium of claim 11, wherein the signature position comprises distances to page margins of the PDF file.
